(19) United States
(12) Patent Application Publication
(10) Pub. No.: US 2015/0347561 A1
(43) Pub. Date: Dec. 3, 2015

(54) METHODS AND SYSTEMS FOR MEDIA COLLABORATION GROUPS

(71) Applicant: THOMSON LICENSING, Issy de Moulineaux (FR)

(72) Inventor: Neil D. VOSS, Darien, CT (US)

(21) Appl. No.: 14/475,226

(22) Filed: Sep. 2, 2014

Related U.S. Application Data
(60) Provisional application No. 62/003,281, filed on May 27, 2014.

(51) Int. Cl. G06F 17/30; G06Q 50/00; H04L 29/06; G06Q 10/10

(52) U.S. Cl. CPC G06F 17/30598; G06Q 10/101; G06Q 50/01; G06F 17/3025; G06F 17/30802; G06F 17/30876; H04L 65/403

(57) ABSTRACT

Methodologies and apparatus for creating, filtering, searching, and posting to collaborative media groups are provided. Collaborative media groups are groups or subsets on media or social sharing sites focused on a particular topic or subject matter of media where users can share media regarding a particular subject, topic, or theme. Users can contribute still images, video or comments or create new groups if a group doesn't already exist and invite new members to contribute. Media contributions to a collaborative media group may also be filtered and searched. The present disclosure provides some improved techniques for this functionality.

### CROSS REFERENCE TO RELATED APPLICATIONS

This application claims priority from U.S. Provisional Application No. 62/003,281 filed May 27, 2014 having attorney docket number PU140089.

### BACKGROUND OF THE INVENTION

Portable electronic devices are becoming more ubiquitous. These devices, such as mobile phones, music players, cameras, tablets and the like often contain a combination of devices, thus rendering carrying multiple objects redundant. For example, current touch screen mobile phones, such as the Apple iPhone or Samsung Galaxy android phone contain video and still cameras, global positioning navigation system, internet browser, text and telephone, video and music player, and more. These devices are often enabled an multiple networks, such as wifi, wired, and cellular, such as 3G, to transmit and received data.

The quality of secondary features in portable electronics has been constantly improving. For example, early “camera phones” consisted of low resolution sensors with fixed focus lenses and no flash. Today, many mobile phones include full high definition video capabilities, editing and filtering tools, as well as high definition displays. With the improved capabilities, many users are using these devices as their primary photography devices. Hence, there is a demand for even more improved performance and professional grade embedded photography tools.

Furthermore, with the increasingly connected nature of portable electronic devices it is easier for users to share their content. There are social networks such as facebook, Twitter, Google Plus, etc, and media sharing sites such as YouTube, Flickr, and the like. Each of which may have dedicated groups or sub-groups for particular topics or subject matter. There are also subject matter specific forums, bulletin board, and blogs. With the proliferation of choices, navigating these choices, and finding the appropriate groups or sub-groups for sharing media can be overly involved.

Thus, it is desirable to overcome these problems with improved methods for creating, filtering, posting to such media sharing sites and service.

### SUMMARY OF THE INVENTION

This summary is provided to introduce a selection of concepts in a simplified form that are further described below in the Detailed Description. The Summary is not intended to identify key features or essential features of the claimed subject matter, not is it intended to be used to limit the scope of the claimed subject matter.

Methodologies and apparatus for creating, filtering, searching, and posting to collaborative media groups are provided in the present disclosure. Collaborative media groups are groups or subsets on media or social sharing sites focused on a particular topic or subject matter of media where users can share media regarding a particular subject, topic, or theme. Users can contribute still images, video or comments or create new groups if a group doesn't already exist and invite new members to contribute. Media contributions to a collaborative media group may also be filtered and searched. The present disclosure provides some improved techniques for this functionality.

### DETAILED DESCRIPTION OF THE DRAWINGS

These and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

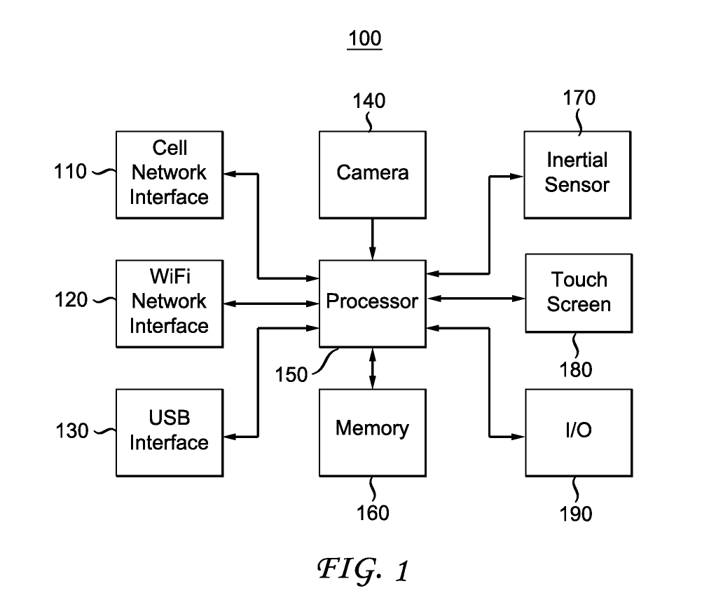

FIG. 1 shows a block diagram of an exemplary embodiment of a mobile electronic device in accordance with the present disclosure;

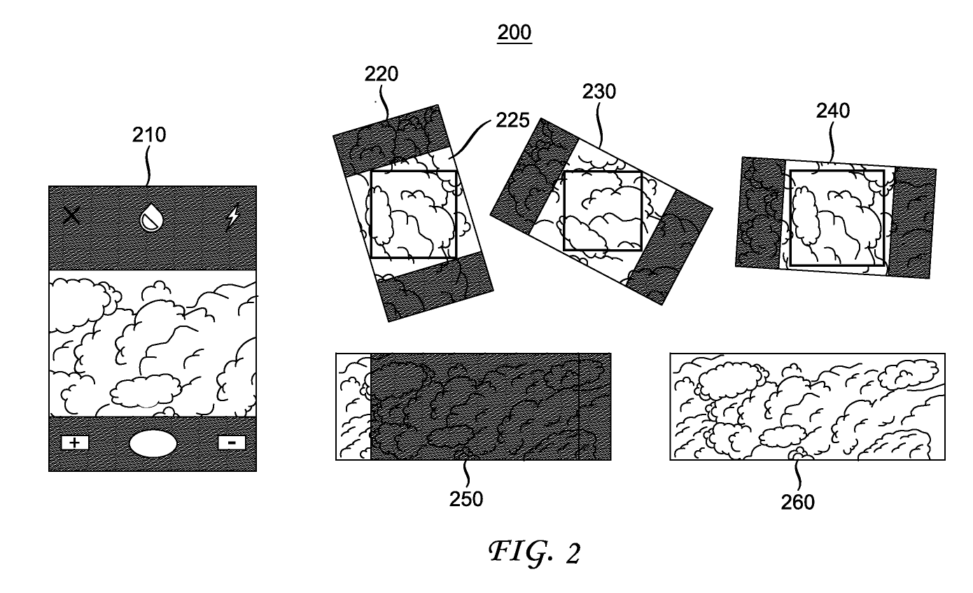

FIG. 2 shows an exemplary mobile device display having an active display in accordance with the present disclosure;

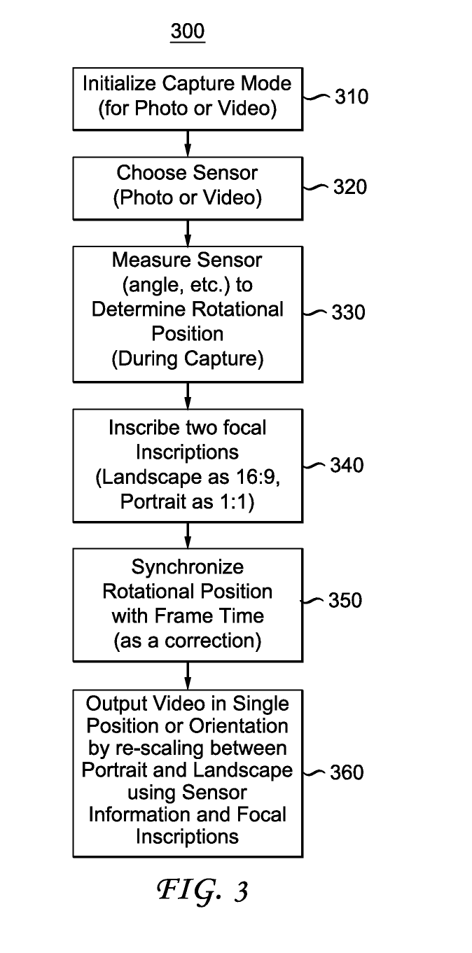

FIG. 3 shows an exemplary process for image stabilization and reframing in accordance with the present disclosure;

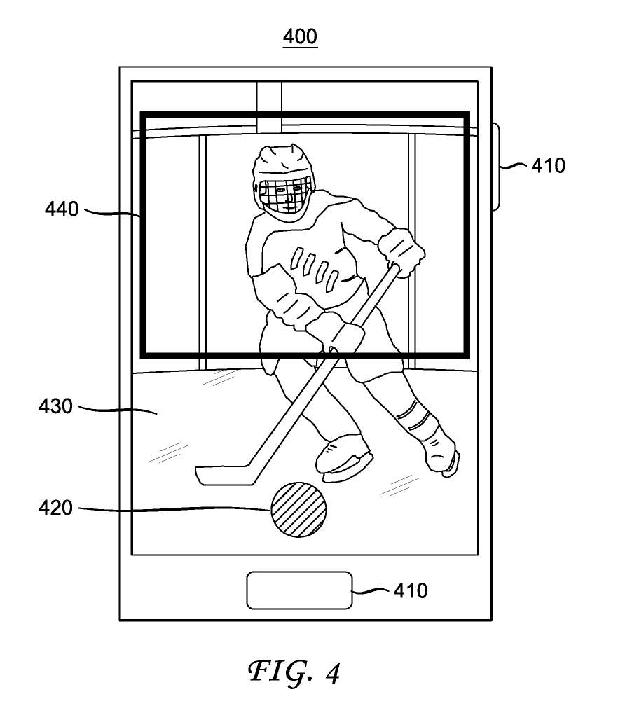

FIG. 4 shows an exemplary mobile device display having a capture initialization in accordance with the present disclosure;

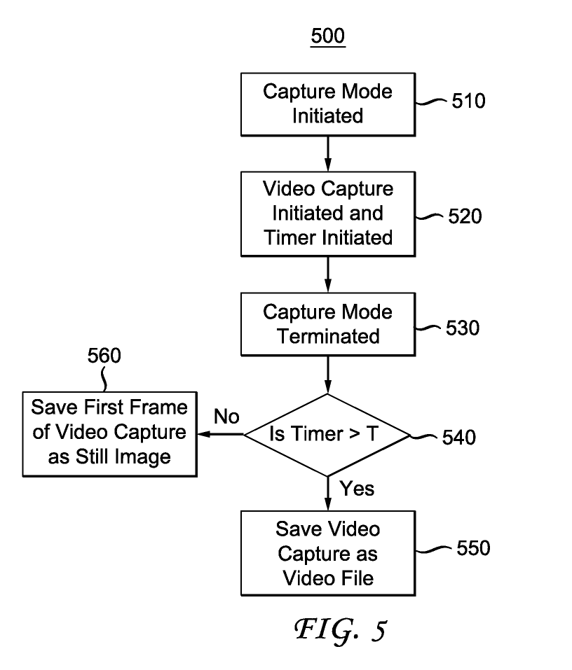

FIG. 5 shows an exemplary process for initiating an image or video capture in accordance with the present disclosure;

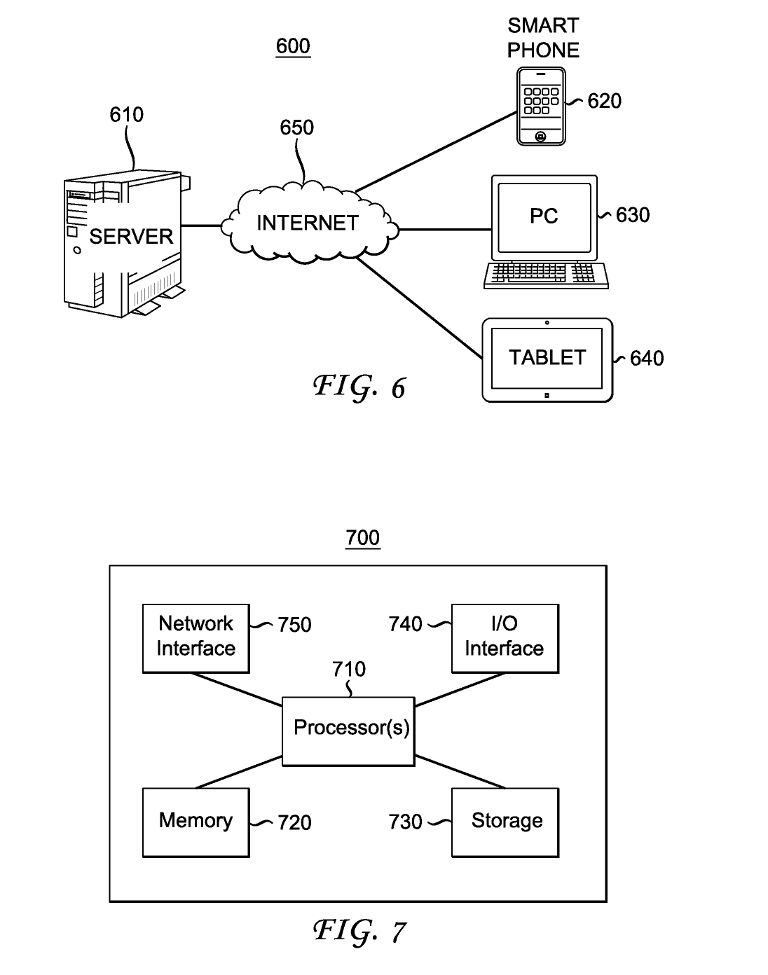

FIG. 6 depicts a block schematic diagram of a system in which collaborative media groups can be implemented according to an embodiment;

FIG. 7 depicts a block schematic diagram of an electronic device for implementing the methodology for collaborative media groups according to an embodiment;

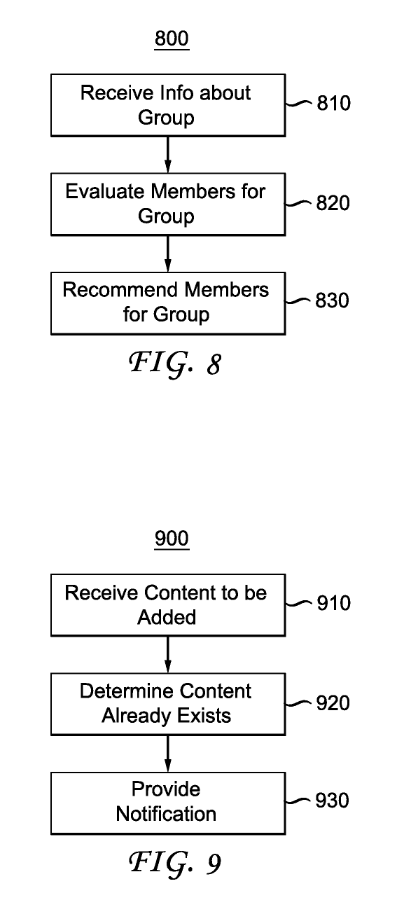

FIG. 8 shows and exemplary process for recommending collaborators for a collaborative media group in accordance with the present disclosure;

FIG. 9 shows and exemplary process for filtering content in a collaborative media group in accordance with the present disclosure;

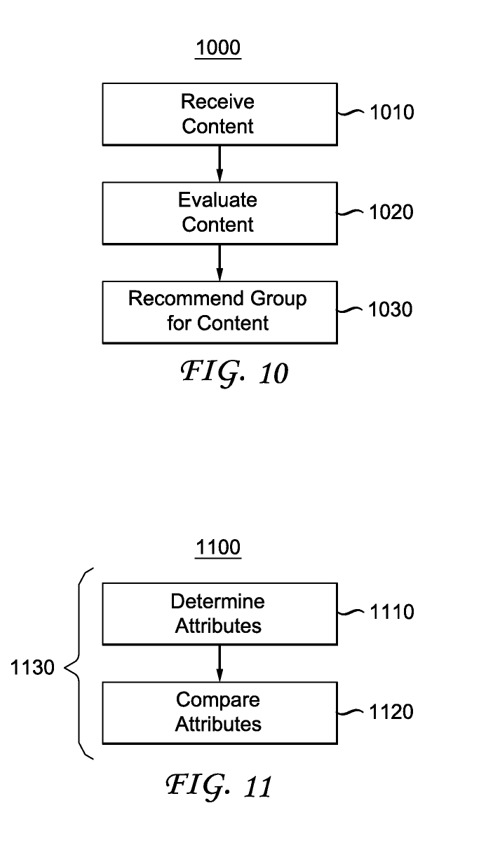

FIG. 10 shows an exemplary process for recommending a collaborative media group in accordance with the present disclosure;

FIG. 11 shows an exemplary process for evaluating content as set forth in FIG. 10 in accordance with the present disclosure;

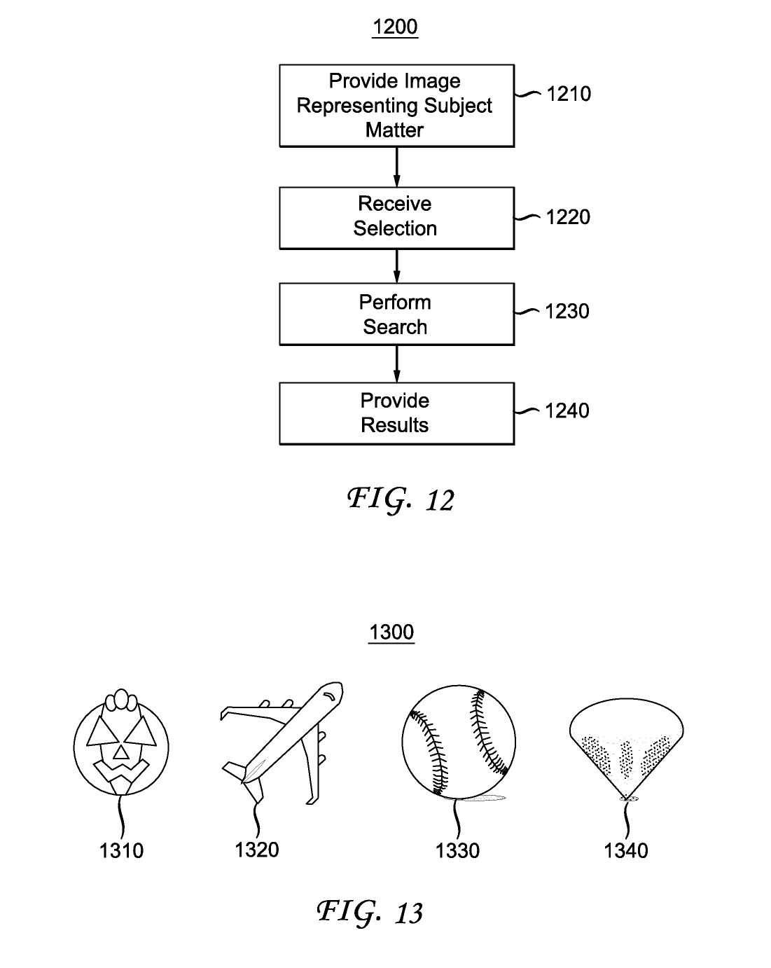

FIG. 12 shows an exemplary process of searching in accordance with the present disclosure; and

FIG. 13. depict exemplary images representing subject matter in accordance with FIG. 12.

### DETAILED DESCRIPTION OF THE PREFERRED EMBODIMENT

The examples set out herein illustrate preferred embodiments of the invention, and such examples are not to be construed as limiting the scope of the invention in any manner.

Referring to FIG. 1, a block diagram of an exemplary embodiment of mobile electronic device is shown. While the depicted mobile electronic device is a mobile phone 100, the invention may equally be implemented on any number of devices, such as music players, cameras, tablets, global positioning navigation systems, etc. A mobile phone typically includes the ability to send and receive phone calls and text messages, interface with the Internet either through the cellular network or a local wireless network, take pictures and videos, play back audio and video content, and run applications such as word processing, programs, or video games. Many mobile phones include GPS and also include a touch screen panel as part of the user interface.

The mobile phone includes a main processor 150 that is coupled to each of the other major components. The main processor 150 may be a single processor or more than one processor as known by one skilled in the art. The main processor 150, or processors, routes the information between the various components, such as the network interfaces 110, 120, camera 140, inertial sensor 170, touch screen 180, and other input/output (“I/O”) interfaces 190. The main processor 150 also processes audio and video content for play back either directly on the device or on an external device through the audio/video interface. The main processor 150 is operative to control the various sub devices, such as the camera 140, inertial sensor 170 touch screen 180, and the USB interface 130. The main processor 150 is further operative to execute subroutines in the mobile phone used to manipulate data similar to a computer. For example, the main processor may be used to manipulate image files after a photo has been taken by the camera function 140. These manipulations may include cropping, compression, color and brightness adjustment, and the like.

The cell network interface 110 is controlled by the main processor 150 and is used to receive and transmit information over a cellular wireless network. This information may be encoded in various formats, such as time division multiple access (TDMA), code division multiple access (CDMA) or Orthogonal frequency-division multiplexing (OFDM). Information is transmitted and received from the device trough the cell network interface 110. The interface may consist of multiple antennas encoders, demodulators and the like used to encode and decode information into the appropriate formats for transmission. The cell network interface 110 may be used to facilitate voice or text transmissions, transmit and receive information from the internet, etc. The information may include video, audio, and/or images.

The wireless network interface 120, or wifi network interface, is used to transmit and receive information over a wifi network. This information can be encoded in various formats according to different wifi standards, such as 802.11g, 802.11b, 802.11ac and the like. The interface may consist of multiple antennas encoders, demodulators and the like used to encode and decode information into the appropriate formats for transmission and decode information for demodulation. The wifi network interface 120 may be used to facilitate voice or text transmissions, transmit and receive information from the internet, etc. This information may include video, audio, and/or images.

The universal serial bus (USB) interface 130 is used to transmit and receive information over a wired link, typically to a computer or other USB enabled device. The USB interface 120 can be used to transmit and receive information, connect to the internet, transmit and receive voice and text calls, etc. Additionally, the wired link may be used to connect the USB enabled device to another network using the mobile devices cell network interface 110 or the wifi network interface 120. The USB interface 130 can be used by the main processor 150 to send and receive configuration information to a computer.

A memory 160, or storage device, may be coupled to the main processor 150. The memory 160 may be used for storing specific information related to operation of the mobile device and needed by the main processor 150. The memory 160 may be used for storing audio, video, photos, or other data stored and retrieved by a user.

The inertial sensor 170 may be a gyroscope, accelerometer, axis orientation sensor, light sensor or the like, which is used to determine a horizontal and/or vertical indication of the position of the mobile device.

The input output (I/O) interface 190, includes buttons, a speaker/microphone for use with phone calls, audio recording and playback, or voice activation control. The mobile device may include a touch screen 180 coupled to the main processor 150 through a touch screen controller. The touch screen 180 may be either a single touch or multi touch screen using one or more of a capacitive and resistive touch sensor. The smartphone may also include additional user controls such as, but not limited to, an on/off button, an activation button, volume controls, ringer controls, and a multi-button keypad or keyboard

Turning now to FIG. 2, an exemplary mobile device display having an active display 200 according to the present disclosure is shown. The exemplary mobile device application is operative for allowing a user to record in any framing and freely rotate the user's device while shooting, visualizing the final output in an overlay on the device's viewfinder during shooting and ultimately correcting for the devices orientation in the final output.

According to the exemplary embodiment, when a user begins shooting, the user's current orientation is taken into account and the vector of gravity based on the device's sensors is used to register a horizon. For each possible orientation, such as portrait 210, where the device's screen and related optical sensor is taller than wide, or landscape 250, where the device's screen and related optical sensor is wider than tall, an optimal target aspect ratio is chosen. An inset rectangle 225 is inscribed within the overall sensor that is best-fit to the maximum boundaries of the sensor given the desired optimal aspect ratio for the given (current) orientation. The boundaries of the sensor are slightly padded in order to provide ‘breathing room’ for correction. The inset rectangle 225 is transformed to compensate for rotation 220, 230, 240 by essentially rotating in the inverse of the device's own rotation, which is sampled from the device's integrated gyroscope. The transformed inner rectangle 225 is inscribed optimally inside the maximum available bounds of the overall sensor minus the padding. Depending on the device's current most orientation, the dimensions of the transformed inner rectangle 225 are adjusted to interpolate between the two optimal aspect ratios, relative to the amount of rotation.

For example, if the optimal aspect ratio selected for portrait orientation was square (1:1) and the optimal aspect ratio selected for landscape orientation was wide (16:9), the inscribed rectangle would interpolate optimally between 1:1 and 16:9 as it is rotated from one orientation to another. The inscribed rectangle is sampled and then transformed to fit an optimal output dimension. For example, if the optimal output dimension is 4:3 and the sampled rectangle is 1:1, the sampled rectangle would either be aspect filled (fully filling the 1:1 area optically, cropping data as necessary) or aspect fit (fully fitting inside the 1:1 area optically, blacking out any unused area with ‘letter boxing’ or ‘pillar boxing’). In the end the result is a fixed aspect asset where the content framing adjusts based on the dynamically provided aspect ratio during correction. So for example a 16:9 video comprised of 1:1 to 16:9 content would oscillate between being optically filled 260 (during 16:9 portions) and fit with pillar boxing 250 (during 1:1 portions).

Additional refinements whereby the total aggregate of all movement is considered and weighed into the selection of optimal output aspect ratio are in place. For example, if a user records a video that is ‘mostly landscape’ with a minority of portrait content, the output format will be a landscape aspect ratio (pillar boxing the portrait segments). If a user records a video that is mostly portrait the opposite applies (the video will be portrait and fill the output optically, cropping any landscape content that falls outside the bounds of the output rectangle).

Referring now to FIG. 3, an exemplary process for image stabilization and reframing 300 in accordance with the present disclosure is shown. The system is initialized in response to the capture mode of the camera being initiated 310. The initialization may be initiated according to a hardware or software button, or in response to another control signal generated in response to a user action. Once the capture mode of the device is initiated, the mobile device sensor is chosen 320 in response to user selections. User selections may be made through a setting on the touch screen device, through a menu system, or in response to how the button is actuated. For example, a button that is pushed once may select a photo sensor, while a button that is held down continuously may indicate a video sensor. Additionally, holding a button for a predetermined time, such as 3 seconds, may indicate that a video has been selected and video recording on the mobile device will continue until the button is actuated a second time.

Once the appropriate capture sensor is selected, the system then requests 330 a measurement from an inertial sensor 170. The inertial sensor 170 may be a gyroscope, accelerometer, axis orientation sensor, light sensor or the like, which is used to determine a horizontal and/or vertical indication of the position of the mobile device. The measurement sensor may send periodic measurements to the controlling processor thereby continuously indicating the vertical and/or horizontal orientation of the mobile device. Thus, as the device is rotated, the controlling processor can continuously update the display and save the video or image in a way which has a continuous consistent horizon.

After the inertial sensor 170 has returned an indication of the vertical and/or horizontal orientation of the mobile device, the mobile device depicts 340 an inset rectangle on the display indicating the captured orientation of the video or image. As the mobile device is rotated, the system processor continuously synchronizes 350 inset rectangle with the rotational measurement received from the inertial sensor.

They user may optionally indicate a preferred final video or image ration, such as 1:1, 9:16, 16:9, or any other ratio selected by the user. The system may also store user selections for different ratios according to orientation of the mobile device. For example, the user may indicate a 1:1 ratio for video recorded in the vertical orientation, but a 16:9 ratio for video recorded in the horizontal orientation. In this instance, the system may continuously or incrementally rescale video 360 as the mobile device is rotated. Thus a video may start out with a 1:1 orientation, but could gradually be rescaled to end in a 16:9 orientation in response to a user rotating from a vertical to horizontal orientation while filming. Optionally, a user may indicate that the beginning or ending orientation determines the final ratio of the video.

Turning now to FIG. 4, an exemplary mobile device display having a capture initialization 400 according to the present disclosure is shown. An exemplary mobile device is shown depicting a touch tone display for capturing images or video. According to an aspect of the disclosure, the capture mode of the exemplary device may be initiated in response to a number of actions. Any of hardware buttons 410 of the mobile device may be depressed to initiate the capture sequence. Alternatively, a software button 420 may be activated through the touch screen to initiate the capture sequence. The software button 420 may be overlaid on the image 430 displayed on the touch screen. The image 430 acts as a viewfinder indicating the current image being captured by the image sensor. An inscribed rectangle 440, as described previously, may also be overlaid on the image to indicate an aspect ratio of the image or video be captured.

Referring now to FIG. 5, an exemplary process for initiating an image or video capture 500 in accordance with the present disclosure is shown. Once the imaging software has been initiated, the system waits for an indication to initiate image capture. Once the image capture indication has been received 510 by the main processor, the device begins to save 520 the data sent from the image sensor. In addition, the system initiates a timer. The system then continues to capture data from the image sensor as video data. In response to a second indication from the capture indication, indicating that capture has been ceased 530, the system stops saving data from the image sensor and stops the timer.

The system then compares 540 the timer value to a predetermined time threshold. The predetermined time threshold may be a default value determined by the software provider, such as one second for example, or it may be a configurable setting determined by a user. If the timer value is less than the predetermined threshold 540, the system determines that a still image was desired and saves 560 the first frame of the video capture as a still image in a still image format, such as jpeg or the like. The system may optionally chose another frame as the still image. If the timer value is greater than the predetermined threshold 540, the system determines that a video capture was desired. The system then saves 550 the capture data as a video file in a video file format, such as mpeg or the like. The system may then return to the initialization mode, waiting for the capture mode to be initiated again. If the mobile device is equipped with different sensors for still image capture and video capture, the system may optionally save a still image from the still image sensor and start saving capture data from the video image sensor. When the timer value is compared to the predetermined time threshold, the desired data is saved, while the unwanted data is not saved. For example, if the timer value exceeds the threshold time value, the video data is saved and the image data is discarded.

Once a user has recorded media, either still images or videos, the user may want to share the recorded media. One such way to share is using social network or media sharing sites. In many instances an app already exists on the user's personal electronic device to post or otherwise contribute media to such sites. In certain embodiments, the same application that can provide the media capture functionality discussed above also includes functionality for sharing the captured media. For ease of content organization and management, many sites and service that offer media hosting and sharing functionality make use of collaborative media groups.

Collaborative media groups are groups or subsets on media or social sharing sites focused on a particular topic or subject matter of media where users can share media regarding a particular subject, topic, or theme. Users can contribute still images, video or comments or create new groups if a group doesn't already exist and invite new members to contribute. Media contributions to a collaborative media group may also be filtered and searched. The present disclosure provides some improved techniques for this functionality. While the discussed embodiments and implementations focus mostly on collaborative media groups, one skilled in the art would understand the concepts set forth could be applied in other scenarios and embodiments.

FIG. 6 depicts a block diagram of an embodiment of a system 600 for implementing asset driven workflow modeling is provided. The system includes a server 610 and one or more electronic devices such as smart phones 620, personal computers (PCs) 630, such as desktops or laptops, and tablets 640 in communication with the server 610 over the internet 650. In certain embodiments, the server 610 provides the environment, including processing and storage, for the asset driven workflow modeling. Users interface with the asset driven workflow model on the server 610 using a browser or application on the electronic devices such as smart phones 620, PCs 630, or tablets 640. In other embodiments, part, or all, of the asset driven workflow modeling can be performed on the one or more electronic devices such as smart phones 620, personal computers (PCs) 630, such as desktops or laptops, and tablets 140.

FIG. 7 depicts an exemplary server 700, or electronic device, that can be used to implement the methodology and system for collaborative media groups disclosed herein. The server or electronic device includes one or more processors 710, memory 720, storage 730, input/output (I/O) interface 740, and a network interface 750. Each of these elements will be discussed in more detail below.

The processor 710 controls the operation of the server 700 or electronic device. The processor 710 runs the software that operates the server or electronic device as well as provides the functionality of the asset driven workflow modeling application. The processor 710 is connected to memory 720, storage 730, input/output (I/O) interface 740, and network interface 750, and handles the transfer and processing of information between these elements. The processor 710 can be general processor or a processor dedicated for a specific functionality. In certain embodiments there can be multiple processors.

The memory 720 is where the instructions and data to be executed by the processor are stored. The memory 720 can include volatile memory (RAM), non-volatile memory (EEPROM), or other suitable media.

The storage 730 is where the data used and produced by the processor in executing the functionality of the present disclosure is stored. The storage may be magnetic media (hard drive), optical media (CD/DVD-Rom), or flash based storage. Other types of suitable storage will be apparent to one skilled in the art given the benefit of this disclosure.

The input/output interface 740 handles the receipt of data from input devices such as keyboards, mice, and touch interfaces. The input/output interface 740 also handles to output of data to output devices such as displays and printers.

The network interface 750 handles the communication of the server 700 or electronic device with other devices over a network. Examples of suitable networks include Ethernet networks, Wi-Fi enabled networks, cellular networks, and the like. Other types of suitable networks will be apparent to one skilled in the art given the benefit of the present disclosure.

It should be understood that the elements set forth in FIG. 7 are illustrative. The server 700, or other electronic device, can include any number of elements and certain elements can provide part or all of the functionality of other elements. Other possible implementation will be apparent to on skilled in the art given the benefit of the present disclosure.

Many media sharing services and site allow users to create collaborative media groups for a particular topic, subject, or theme. The creator or owner of a newly created collaborative media group can then invite other users to join and become members of the group who can then post and share media within the group. However, finding potential members who would be a good fit can for the group can be difficult as there may be a large number of potential candidates but no easy mechanism for deciding if a candidate would be appropriate for the group based on interest, personal relationships, or participation with other groups. Thus in accordance with one embodiment recommendations of potential members for a group can be provided.

When a user creates a new group, she is prompted to invite fellow collaborators to the group. A weighted list is provided based on interpersonal relationships i.e. facebook friends, twitter, etc. and subject relationships i.e. active collaborators from related groups, such as black and white photography.

The order of the list of collaborators can be weighted based on service recommending friends, previous collaborations, previous number of accepted collaborations over declined collaborations, and ownership of related groups, level of participation in related groups, collaboration in a large number of related groups, etc. All these categories can be weighted and prioritized by the user.

For example, a user creates a new group about cinemagraphs. During creation of the group, a user is prompted to invite other collaborators to the group. The order that the recommended collaborators is presented is determined. Previously, the user may have selected, or it may have been determined, or it may be a default selection, that personal relationships have a higher priority that topical relationships. Thus, collaborators that the user may have had the most interaction with, such as personal communication, number of groups in common, comments on a user's media, user's comments on the potential collaborators media, etc. Alternatively, the user may determine that other collaborators in groups relating to cinemagraphs may be preferred for recommendation as collaborators. These potential collaborators may be ranked by number of groups created relating to cinemagraphs, number groups that they are collaborators in, number of posts in the groups, etc. Each of these factors may be weighted by a user through a menu system or through previous activity such that a weighted blend of recommended collaborators is generated based on any or all of the factors. The desirable result is that the collaborators of most interest to a user are recommended first in the list. A methodology for implementing this functionality can be seen in FIG. 8.

FIG. 8 depicts a flow diagram 800 of an exemplary methodology for implementing the recommendation of collaborators for a collaborative media group. At the most basic level, the methodology involves three steps. The first step is receiving information regarding a collaborative media group from a user (step 810). The next step is evaluating potential members for the collaborative media group (step 820). The last step of the basic method is providing a recommendation of potential members based on the evaluation (step 830).

In certain embodiments, the receipt of the information regarding a group is from a user setting up the group. This information may include the subject, topic, or theme of the group as well as keywords and search terms to be associated with the group. In other such embodiment the method further includes inviting potential member to join the group. Other implementations and embodiments will be apparent to one skilled in the art.

It should be understood that the methodology and techniques set forth above may be implemented on an electronic device such as the server of FIGS. 7 and 8, the mobile device of FIG. 1, or a combination thereof.

Often in a collaborative media group, media is grouped into collections of like media. Therefore, when there are a large number of contributors, there is a likelihood that images and videos will be reposted multiple times to a group. The present disclosure sets forth a feature that detects reposts and filters the repost out of a user's posts or makes the repost a low priority on viewer's feed. Further, the system may prompt a contributor that an image is already part of the group. This feature prevents feeds from being cluttered with reposts. A methodology for implementing this functionality can be seen in FIG. 9

FIG. 9 depicts a flow diagram 900 of an exemplary methodology for implementing the filtering content in a collaborative media group. At the most basic level, the methodology involves three steps. The first step is receiving content to be added to the collaborative media group (step 910). The next step is determining that the content already exist in the collaborative media group (step 920). The last step of the basic method is providing notification that the content already exist in the collaborative media group (step 930).

In certain embodiments, the method may further include omitting the content from the group or allowing the content to be added but marking it as a repost or giving it a lower ranking. Other implementations and embodiments will be apparent to one skilled in the art.

It should be understood that the methodology and techniques set forth above may be implemented on an electronic device such as the server of FIGS. 7 and 8, the mobile device of FIG. 1, or a combination thereof.

In accordance with another embodiment, when a collaborator uploads media to a service, the service determines attributes and contents of the media and then recommends groups where the media may be appropriate. For example, if a video features an airplane, the system may recommend groups relating to air travel, transportation, aircraft, engineering, sky, and technology. Further, if the media is filmed with a certain filter, such as sepia, the system may recommend vintage, western, antique, etc. A methodology for implementing this functionality can be seen in FIG. 10

FIG. 10 depicts a flow diagram 1000 of an exemplary methodology for implementing the recommending of a collaborative media group based on the content of the media. At the most basic level, the methodology involves three steps. The first step is receiving content or media to be added (step 1010). The next step is evaluating the content based on at least one existing collaborative media group (step 1020). The last step of the basic method is providing a recommendation for which of the existing collaborative media groups the content can be contributed to (step 1030).

In certain embodiments, the step of evaluating (step 1020) can comprise additional steps. An example of this can be seen in FIG. 11.

FIG. 11 depicts a flow diagram 1100 of an exemplary methodology for implementing the step of evaluating (step 1020) in FIG. 10. At the most basic level, the methodology involves two steps. The first step is receiving determining attributes of the content (step 1110). The second and final step is comparing the determined attributes of the content to attributes associated with at least one existing collaborative media group (step 1120). Examples of such attributes include, but are not limited to, subject matter, color, filter, and media type.

It should be understood that the methodology and techniques set forth above may be implemented on an electronic device such as the server of FIGS. 7 and 8, the mobile device of FIG. 1, or a combination thereof.

Since a user is often accessing media from a mobile device which may have limited screen size, being able to provide visual cues or shortcuts can make interfacing with the medium more convenient. For example images, such as pictures, graphics, emoticons, or even emojis can be used as a visual indicator or short hand for concepts, subject matter, or topics. In accordance with one embodiment, emojis emoticons can be used to search for groups and content. A user selects an emoji, such as a “jack o lantern” The system then returns search results associated with jack o lanterns such as Halloween, honor, monsters, autumn, etc. This permits the user to quickly search for content in a way that may be difficult to describe in words. All emojis have associated text with them in the system that assists in searching. A methodology for implementing this functionality can be seen in FIG. 12.

FIG. 12 depicts a flow diagram 1200 of an exemplary methodology for implementing searching using representative images. At the most basic level, the methodology involves four steps. The first step is providing one more images representing subject matter that can be searched for (step 1210). The next step is receiving a selection of the one or more provided image representations (step 1220). The third step is performing a search for subject matter represented by the selected image (step 1230). The last step of the basic method is providing the search results (step 1240).

In certain embodiments, the images representing content are emoticons such a emoji. Examples of some such emojis can be seen in the set 1300 shown in FIG. 13. In this example the emojis are a jack-o-lantern 1310, an airplane 1320, a baseball 1330, and a jewel 1340. The jack-o-lantern 1310, as discussed above could represent Halloween concepts, the airplane 1320 could represent travel concepts, the baseball 1330 could represent sports concept, and the jewel 1340 could represent jewelry or wealth concepts. Other implementations and embodiments will be apparent to one skilled in the art.

It should be understood that the elements shown and discussed above, may be implemented in various forms of hardware, software or combinations thereof. Preferably, these elements are implemented in a combination of hardware and software on one or more appropriately programmed general-purpose devices, which may include a processor, memory and input/output interfaces. The present description illustrates the principles of the present disclosure. It will thus be appreciated that those skilled in the art will be able to devise various arrangements that, although not explicitly described or shown herein, embody the principles of the disclosure and are included within its scope. All examples and conditional language recited herein are intended for informational purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated by those skilled in the art that the block diagrams presented herewith represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

1. A method for recommending collaborators for a collaborative media group, the method comprising:
receiving information regarding a collaborative media group from a user;
evaluating potential members for the collaborative media group; and
providing a recommendation of potential members based on the evaluation.

2. The method of claim 1 wherein the information about the collaborative media group is a request to generate a collaborative media group.

3. The method of claim 1, further comprising inviting potential members to join the collaborative media group.

4. The method of claim 1, wherein the evaluation of potential members is based on one or more criteria selected from the group comprising: membership in other collaborative media groups, participation in collaborative media groups, subject matter of collaborative media group the potential member is already a member of, relationship with other users, and social network relationships.

5. The method of claim 4, wherein the criteria are weighted for evaluation.

6. The method of claim 5, where the weights of criteria are assigned by a user.

7. The method of claim 1, wherein the recommendation comprises a ranking of potential members.

8. An apparatus for recommending collaborators for a collaborative media group, the apparatus comprising:
an interface for receiving and transmitting data;
a memory for holding data;
storage for storing data about collaborative media groups and users; and
a processor in communication with the interface, memory, and storage, the processor configured to receive a information regarding a collaborative media group from a user, evaluate potential members for the collaborative media group, and provide a recommendation of potential members based on the evaluation.

9. The apparatus of claim 8, where further comprising a network interface.

10. The apparatus of claim 8, wherein the apparatus is a server.

11. The apparatus of claim 10 wherein the information about the collaborative media group is a request to generate a collaborative media group.

12. The apparatus of claim 8, wherein the processor is further configured to invite potential members to join the collaborative media group.

13. The apparatus of claim 8, wherein the evaluation of potential members is based on one or more criteria selected from the group comprising: membership in other collaborative media groups, participation in collaborative media groups, subject matter of collaborative media group the potential member is already a member of, relationship with other users, and social network relationships.

14. The apparatus of claim 13, wherein the criteria are weighted for evaluation.

15. The apparatus of claim 14, where the weights of criteria are assigned by the user.

16. The apparatus of claim 8, wherein the recommendation comprises a ranking of potential members.

17. A method of filtering content in a collaborative media group, the method comprising:
receiving content to be added to the collaborative media group;
determining that the content already exist in the collaborative media group; and
providing notification that the content already exist in the collaborative media group.

18. The method of claim 17, wherein the content comprises at least one selected from the group comprising: still images, video, and comments.

19. The method of claim 17, further comprising omitting the content from the collaborative media group.

20. The method of claim 17, further comprising adding the content with an indication that the content already exists in the collaborative media group.

21. The method of claim 17, further comprising adding the content with a lower priority in the collaborative media group.

22. An apparatus for filtering content in a collaborative media group, the apparatus comprising:
an interface for receiving and transmitting data;
a memory for holding data;
storage for storing data about collaborative media groups and users; and
a processor in communication with the interface, memory, and storage, the processor configured to receive content to be added to the collaborative media group, determine if the content already exist in the collaborative media group, and provide notification that the content already exist in the collaborative media group.

23. The apparatus of claim 22, further comprising a network interface.

24. The apparatus of claim 22, wherein the apparatus is a server.

25. The apparatus of claim 22, wherein the content comprises at least one selected from the group comprising: still images, video, and comments.

26. The apparatus of claim 22, wherein the processor is further configured to omit the content from the collaborative media group.

27. The apparatus of claim 22, wherein the processor is further configured to add the content with an indication that is already exists in the collaborative media group.

28. The apparatus of claim 22, wherein the processor is further configured to add the content with a lower priority in the collaborative media group.

29. A method of recommending a collaborative media group, the method comprising:
receiving content for contribution to a collaborative media group;
evaluating the content based on at least one existing collaborative media group; and
providing a recommendation for which of the existing collaborative media groups the content can be contributed to.

30. The method of claim 29, wherein the content comprises at least one selected from the group comprising: still images, video, and comments.

31. The method of claim 29, wherein evaluating the content comprises:
determining attributes of the content; and
comparing the determined attributes of the content to attributes associated with at least one existing collaborative media group.

32. The method of claim 31, wherein the attributes comprise at least one selected from the group comprising: subject matter; color, filters used, and media type.

33. The method of claim 29, further comprising:
receiving a selection of a recommended collaborative media group; and
adding the content to the selected collaborative media group.

34. An apparatus for recommending a collaborative media group, the apparatus comprising:
an interface for receiving and transmitting data;
a memory for holding data;
storage for storing data about collaborative media groups and users; and
a processor in communication with the interface, memory, and storage, the processor configured to receive content for contribution to a collaborative media group, evaluate the content based on at least one existing collaborative media group, and provide a recommendation for which of the existing collaborative media groups the content can be contributed to.

35. The apparatus of claim 34, further comprising a network interface.

36. The apparatus of claim 34, wherein the apparatus is a server.

37. The apparatus of claim 34, wherein the content comprises at least one selected from the group comprising: still images, video, and comments.

38. The apparatus of claim 34, wherein evaluating the content comprises:
determining attributes of the content; and
comparing the determined attributes of the content to attributes associated with at least one existing collaborative media group.

39. The apparatus of claim 38, wherein the attributes comprise at least one selected from the group comprising: subject matter; color, filters used, and media type.

40. The apparatus of claim 34, further comprising:
receiving a selection of a recommended collaborative media group; and
adding the content to the selected collaborative media group.
